(19) United States
(12) Patent Application Publication
(10) Pub. No.: US 2015/0373235 A1
(43) Pub. Date: Dec. 24, 2015

(54) DE-NOISING METHOD AND IMAGE SYSTEM

(71) Applicant: Realtek Semiconductor Corp., HsinChu (TW)

(72) Inventors: Hao-Tien Chiang, Taipei City (TW); Shih-Tse Chen, Hsinchu County (TW)

(21) Appl. No.: 14/748,248

(22) Filed: Jun. 24, 2015

(30) Foreign Application Priority Data
Jun. 24, 2014 (TW) 103121757

(51) Int. Cl. H04N 5/213; H04N 5/235

(52) U.S. Cl. CPC H04N 5/213; H04N 5/2353; H04N 5/2351

(57) ABSTRACT

A decryption engine includes an update circuit, a key generator, a decryption circuit and a detection circuit. The update circuit generates a first updating information based on a premise of that a currently received frame is encrypted, and generates a second updating information based on a premise of that the currently received frame is non-encrypted. The key generator produces a first key according to the first updating information, and produces a second key according to the second updating information. The decryption circuit generates a first decrypted frame according to the first key and the currently received frame, and generates a second decrypted frame according to the second key and the currently received frame. The detection circuit detects whether the currently received frame is decrypted according to the first decrypted frame and the second decrypted frame, to generate an encryption detection result.

### BACKGROUND OF THE INVENTION

1. Field of the Invention

The disclosed embodiments of the present invention relate to an image system, and more particularly, to a de-noising method and a related image system.

2. Description of the Prior Art

In the real-time digital image process, there are mainly two kinds of de-noising methods. The first kind of de-noising method is performed in a spatial domain, such as Gaussian filtering, median filtering, bilateral filtering, and non-local means (NLM) filtering with good effect. However, these spatial domain de-noising method needs a huge calculation amount to obtain a better effect, and there are side effects of image blur and details loss inevitably.

The second kind of de-noising method is performed in a time domain, which considers a previous frame and a current frame at the same time with an appropriate weighted average in order to achieve the de-noising effect. Compared to the first kind of de-noising method, the top advantage is that it almost does not cause image blur or the detail loss, but the time domain de-noising method may easily increase the ghosting, or make the image not natural. Minimizing the side effects often requires very complex operation.

In order to improve problems of the de-noising methods of time domain and space domain, it is also practical to merge the two kinds of methods, but a de-noising method using the time domain and the space domain at the same time will have three major problems: the first problem is a serious ghosting effect; the second problem is low image resolution; and the third problem is that when the noise is bigger, especially when the image capturing device is in a low light environment, or the image is affected by the lens shading around, the de-noising effect will be reduced.

Thus, a de-noising method with low complexity and high efficiency is required in this field to improve the above problems.

### SUMMARY OF THE INVENTION

It is therefore one of the objectives of the present invention to provide a de-noising method and a related image system, so as to solve the above-mentioned problem.

In accordance with a first embodiment of the present invention, an exemplary de-noising method is disclosed. The de-noising method comprises: receiving a pixel of a current frame; deriving a de-noising coefficient according to a specific information corresponding to the pixel; and generating an output pixel by allocating a weight of the pixel and a weight of at least one pixel of a previous frame according to the de-noising coefficient, wherein the at least one pixel of the previous frame includes a co-located pixel.

In accordance with a second embodiment of the present invention, an exemplary image system is disclosed. The image system comprises: a lens module, an image and signal processor, and a de-noising unit. The lens module is utilized for capturing an image information. The image and signal processor is coupled to the lens module, and utilized for converting the image information to a frame. The de-noising unit is coupled to the image and signal processor, and utilized for: receiving a pixel of the frame; deriving a de-noising coefficient according to a specific information corresponding to the pixel; and generating an output pixel by allocating a weight of the pixel and a weight of at least one pixel of a previous frame according to the de-noising coefficient, wherein the at least one pixel of the previous frame includes a co-located pixel.

In accordance with a second embodiment of the present invention, an exemplary image system is disclosed. The image system comprises: a lens module, an image and signal processor, a brightness adjusting unit, and a de-noising unit. The lens module is utilized for capturing an image information. The image and signal processor is coupled to the lens module, and utilized for converting the image information to a frame. The brightness adjusting unit is coupled between the image and signal processor and the lens module, and utilized for generating an exposure control signal to the lens module according to an automatic exposure information and generating a frame rate information to a de-noising unit. The de-noising unit is utilized for: receiving a pixel of the frame; deriving a de-noising coefficient according to a specific information corresponding to the pixel; and generating an output pixel by allocating a weight of the pixel and a weight of at least one pixel of a previous frame according to the de-noising coefficient, wherein the at least one pixel of the previous frame includes a co-located pixel, and at least one pixel of the previous frame further comprises at least one pixel surround the co-located pixel.

In accordance with a second embodiment of the present invention, an exemplary image system is disclosed. The image system comprises: a lens module, an image and signal processor, a brightness adjusting unit, and a de-noising unit. The lens module is utilized for capturing an image information. The image and signal processor is coupled to the lens module, and utilized for converting the image information to a frame. The brightness adjusting unit is coupled between the image and signal processor and the lens module, and utilized for generating an exposure control signal to the lens module according to an automatic exposure information and generating a frame rate information to a de-noising unit. The de-noising unit is utilized for performing a spatial domain de-noising process and a time domain de-noising process at least according to the frame rate information and a pixel of the frame, so as to generate an output pixel.

Briefly summarized, the spirit of the present invention is using an adaptivity method to dynamically determine a ratio of the time domain de-noising, and further adding the spatial domain de-noising to achieve a real-time 3D de-noising method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified schematic diagram illustrating a real-time adaptability 3D dynamic de-noising method according to the present invention.

FIG. 2 is a diagram of a filtering function ƒ₂ in accordance with an embodiment of the present invention.

FIG. 3 shows a flowchart of an exemplary real-time adaptability 3D dynamic de-noising method in accordance with a first embodiment of the present invention

FIG. 4 is a relation diagram of the brightness and the Weber threshold value of the present invention.

FIG. 5 is a relation diagram of the motion strength and the preposed de-noising coefficient of the present invention.

FIG. 6 is a relation diagram of the distance from the center point of the frame and the adjusting coefficient in accordance with an embodiment of the present invention.

FIG. 7 is a relation diagram of the distance from the center point of the frame and the adjusting coefficient in accordance with another embodiment of the present invention.

FIG. 8 shows a flowchart of an exemplary real-time adaptability 3D dynamic de-noising method in accordance with a second embodiment of the present invention.

FIG. 9 is a block diagram of an image system in accordance with an embodiment of the present invention.

FIG. 10 shows a flowchart of an exemplary real-time adaptability 3D dynamic de-noising method in accordance with a third embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

In general, in order to obtain a better de-noising effect, the characteristics of the noises have to be analyzed at first. There are two kinds of common static state image noises: salt and pepper noise and Gaussian noise. However, for the general image capturing devices, since the captured images are dynamic and the noises of each frame might be different, and the noises of each point are twinkling constantly for the vision (i.e. the whole frame is full of twinkling noises), the effect of using the spatial domain to perform the de-noising process will not be ideal in this condition, and it is more proper to use the time domain filter or use the time domain plus the spatial domain to perform the de-noising process.

The spirit of the present invention is using an adaptivity method to dynamically determine a ratio of the time domain de-noising, and further adding the spatial domain de-noising to achieve a real-time 3D de-noising method. In the 3D de-noising method, the way of how to allocate the time domain de-noising strength (effect) will directly affect the user feeling. The present invention is suitable for all camera modules and shot environments. In a low light environment, for example, two different time points of captured frame are not only full of static noise, buy also contains dynamic twinkling noises. Therefore, the present invention can reduce the dynamic twinkling noise to enhance the visual perception in as far as possible under the condition of no loss of image details. In addition, the computational cost of the present invention is very low, and the present invention can be used in a variety of different ways of implementation, such as a hardware (such as a chip), a software (such as a driver, an application) or a firmware or a part or all of their combination.

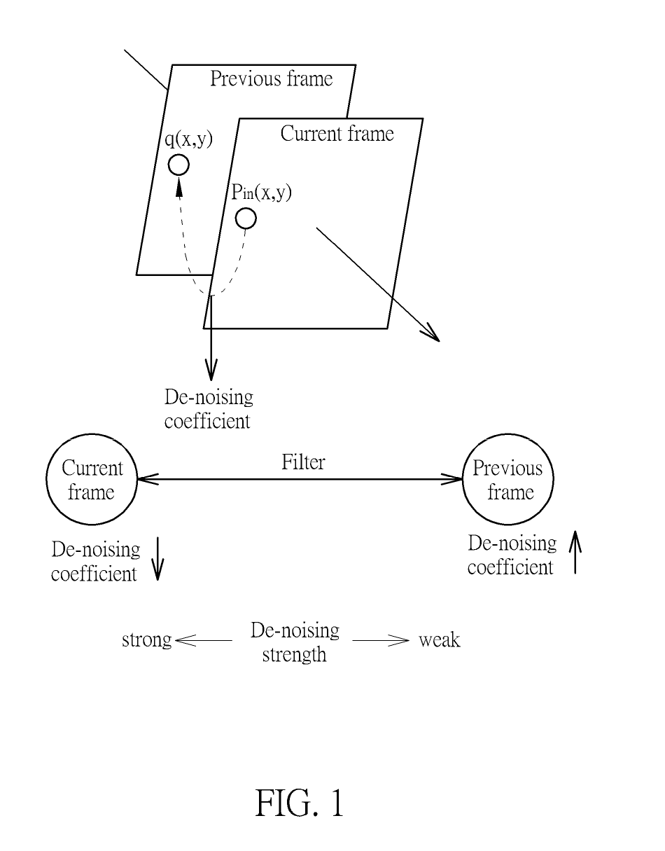

Please refer to FIG. 1. FIG. 1 is a simplified schematic diagram illustrating a real-time adaptability 3D dynamic de-noising method according to the present invention. Equation (1) is the basic idea of the present invention, based on a current frame and a previous frame for a filter process. Please note that the previous frame is not limited to previous one frame. The filter process can be expressed as follows:

Pₒᵤₜ=Pᵢₙ×C_{denoising}+ƒ₃(q)×(1−C_{denoising}) (1)

Pᵢₙ is a value of a pixel in the current frame, and q is a value of another pixel in the corresponding position in the previous frame (co-located pixel), Pₒᵤₜ is a result generated by the filtering process (i.e. a new value of the pixel in the current frame). More specifically, an integrated de-noising coefficient C_{denoising} is utilized here, and a dynamic determining method is utilized for determining an integrated de-noising coefficient C_{denoising} which is most suitable for the pixel. As shown in the equation (1), when the integrated de-noising coefficient C_{denoising} is larger, the output value is determined more by the value Pᵢₙ of the pixel in the current frame. When the integrated de-noising coefficient C_{denoising} is smaller, the output value is determined more by the value q of the pixel in the corresponding position in the previous frame. In other words, when the integrated de-noising coefficient C_{denoising} in FIG. 1 is larger, the effect and strength of the filtering process for the 3D time domain are weaker. When the integrated de-noising coefficient C_{denoising} in FIG. 1 is smaller, the effect and strength of the filtering process for the 3D time domain are stronger. One of the key figure of the present invention is how to determine the integrated de-noising coefficient C_{denoising} most suitable for each pixel in the current frame. About the filtering function ƒ₃, it is utilized for processing another pixel in the corresponding position in the previous frame. For example, the filtering function ƒ₃ can be the conventional de-noising filtering method of spatial domain such as the median filtering method, the bilateral filtering method, and the non-local means (NLM) filtering method, and the present invention is not limited to these filtering methods. In a preferred embodiment, the filtering function ƒ₃ is belong to an edge protection filtering method to keep the details as far as possible.

The above equation (1) can be further represented in equation (2) as follows.

Pₒᵤₜ=Pᵢₙ×ƒ₁(ƒ₂(C₁,C₂, . . . ,Cₙ))+ƒ₃(q)×(1−ƒ₁(ƒ₂(C₁,C₂, . . . ,Cₙ)) (2)

The integrated de-noising coefficient C_{denoising} in the equation (1) is represented by ƒ₁(ƒ₂(C₁, C₂, . . . , Cₙ)). The filtering function ƒ₁ is a global mapping function, and this function can perform a whole adjustment for the de-noising coefficient. For example, it is practical to use the filtering function ƒ₁ to perform a global gain process for an input to directly change the input strength according to the characteristics of the lens and/or the light sensing element, and generate an output to obtain the stable effect and prevent from affected by different lens, and the present invention is not limited to this condition. If the output of the filtering function ƒ₁ is larger than the input, it means that the filtering function ƒ₁ increases the input strength. If the output of the filtering function ƒ₁ is smaller than the input, it means that the filtering function ƒ₁ decreases the input strength.

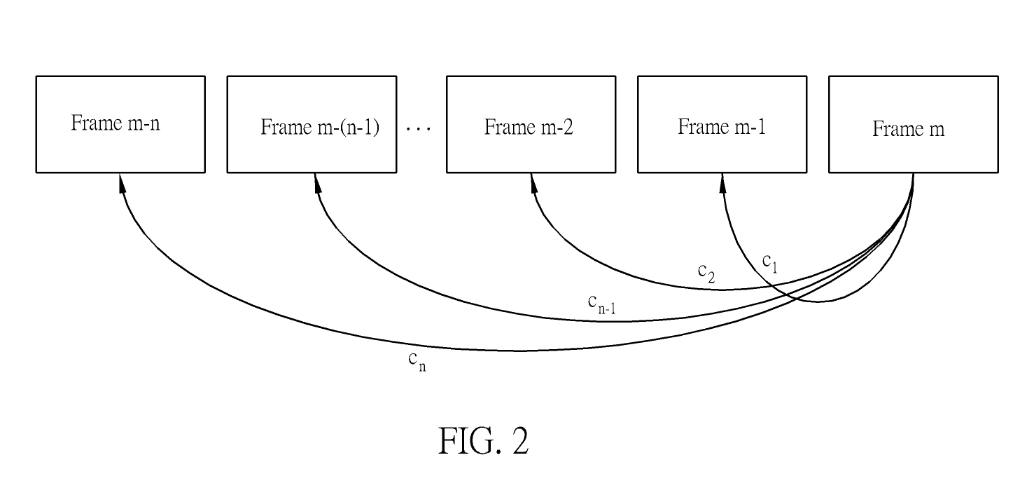

FIG. 2 is a diagram of a filtering function ƒ₂ in accordance with an embodiment of the present invention, wherein an input of the filtering function ƒ₂ is a number n of individual de-noising coefficients corresponding to a number n of previous frames (i.e. frame m−1˜frame m-n) of a current frame m. The individual de-noising coefficient C₁ is derived according to the current frame m and the previous frame m−1. The individual de-noising coefficient C₂ is derived according to the current frame m and the previous frame m−2, and so on, where n is a positive integer greater than or equal to 1, and if n is 1, said only refer to the previous frame. The filtering function ƒ₂ is utilized for filtering each individual de-noising coefficient C₁, C₂, . . . , Cₙ to obtain the integrated de-noising coefficient C_{denoising}. The filtering method of the filtering function ƒ₂ can be different method, such as Gaussian filtering method or median filtering method. Or, the output of the filtering function ƒ₂ can be a maximum value of C₁˜Cₙ, to reduce the strength of the de-noising effect of the time domain as far as possible, so as to reduce the probability of the occurrence of the ghosting. The output of the filtering function ƒ₂ also can be a mean value of C₁˜Cₙ, to average use the individual de-noising coefficients of the current frame and the number n of previous frames, so as to reduce the probability of the occurrence of the error. However, the present invention is not limited to the embodiment in FIG. 2, or the above example. In addition, please note that the equation (2) should be performed for each pixel in the current frame, and continue to repeat the calculation when information of a next frame is received.

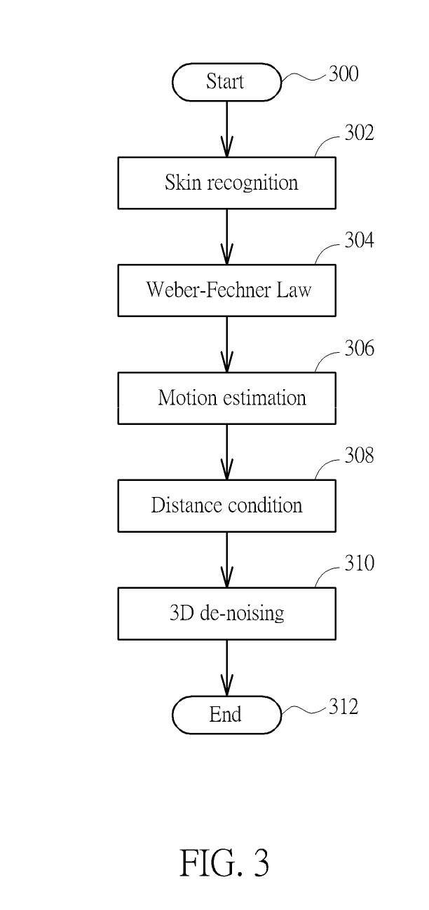

Please refer to FIG. 3. FIG. 3 shows a flowchart of an exemplary real-time adaptability 3D dynamic de-noising method in accordance with a first embodiment of the present invention, comprising five main steps of skin recognition, Weber-Fechner Law, motion estimation, distance condition, and 3D de-noising. Provided that substantially the same result is achieved, the steps of the process flowchart do not have to be in the exact order shown in FIG. 3 and need not be contiguous, meaning that other steps can be intermediate. In addition, some steps in FIG. 3 can be omitted according to different embodiments or design requirements.

In the step 302 in FIG. 3, the main purpose is to determine the area of the skin color. The area of the skin color is probably the human body part (especially the human face), which tends to have a larger motion, and usually is most attention by the user's eyes. Thus, the skin recognition can be utilized for prevent the human face from generating un-natural image or ghosting. The step 302 can use the conventional human face identifying method, such as using whether the values of red (R), green (G) and blue (B) channels of the pixel fit R>G>B to determine the area of the skin color. A skin color threshold value thdₛₖᵢₙ is set, wherein when an area is closer to the skin color, skin color, the skin color threshold value thdₛₖᵢₙ will be lower. When an area is not closer to the skin color, the skin color threshold value thdₛₖᵢₙ will be higher. The skin color threshold value thdₛₖᵢₙ will be utilized in the motion estimation in the step 306.

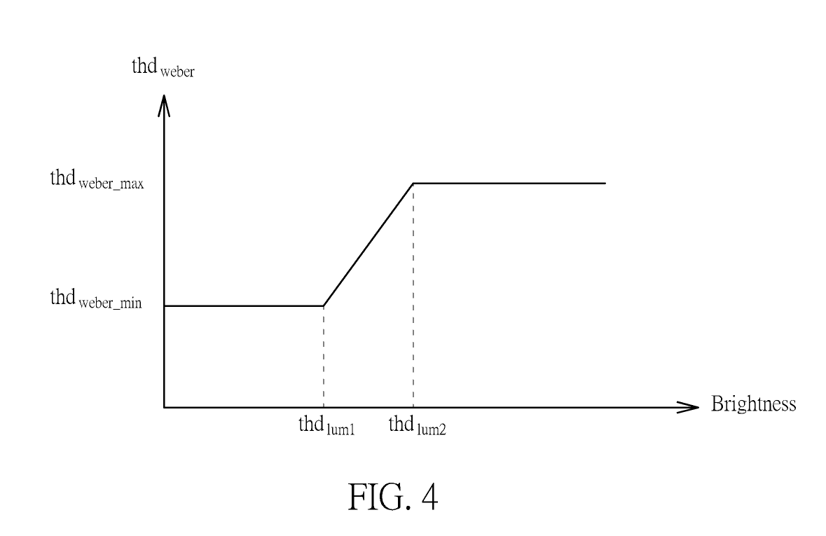

In the step 304, the motion adjustment is performed according to the brightness based on Weber-Fechner Law. Weber-Fechner Law applied to image processing can get the following conclusion: for a fixed size of noise, in the place of the higher brightness, the noise is harder to be paid attention by the human's eyes, and in the place of the lower brightness, the noise is easier to be paid attention by the human's eyes. Thus, according to the above conclusion, a dynamic Weber threshold value thd_{weber} is designed in the step 304, wherein thd_{weber}_{_{—}}ₘᵢₙ≦Weber threshold value thd_{weber}≦thd_{weber}_{_{—}}ₘₐₓ. FIG. 4 is a relation diagram of the brightness and the Weber threshold value of the present invention. As shown in FIG. 4, when the brightness is higher, the Weber threshold value thd_{weber}_{_{—}}ₘᵢₙ is higher, and when the brightness is lower, the Weber threshold value thd_{weber}_{_{—}}ₘᵢₙ is lower. The Weber threshold value thd_{weber}_{_{—}}ₘᵢₙ will be utilized in the motion estimation in the step 306.

In the step 306, a motion strength Difference between the current frame and the previous k (k=1˜n) frame is calculated. When the motion strength Difference is larger, it means that the motion level is higher, and when the motion strength Difference is smaller, it means that the motion level is lower. The motion strength Difference is defined as follows:

$$Differece = \vert [ \begin{matrix}{p}_{i , j} & ⋯ & {p}_{i , j + k} \\ ⋮ & ⋱ & ⋮ \\ {p}_{i + 1 , j} & ⋯ & {p}_{i + 1 , j + k}\end{matrix} ] * [ \begin{matrix}{a}_{i , j} & ⋯ & {a}_{i , j + k} \\ ⋮ & ⋱ & ⋮ \\ {a}_{i + 1 , j} & ⋯ & {a}_{i + 1 , j + k}\end{matrix} ] - [ \begin{matrix}{q}_{i , j} & ⋯ & {q}_{i , j + k} \\ ⋮ & ⋱ & ⋮ \\ {q}_{i + 1 , j} & ⋯ & {q}_{i + 1 , j + k}\end{matrix} ] * [ \begin{matrix}{a}_{i , j} & ⋯ & {a}_{i , j + k} \\ ⋮ & ⋱ & ⋮ \\ {a}_{i + 1 , j} & ⋯ & {a}_{i + 1 , j + k}\end{matrix} ] \vert \qquad ( 3 )$$

*is a representative of the rotating calculation, and p_{i,j} is a representative of a current pixel of coordinate position (i,j), and q_{i,j} is a representative of a pixel of coordinate position (i,j) in a previous frame.

$$[ \begin{matrix}{p}_{i , j} & ⋯ & {p}_{i , j + k} \\ ⋮ & ⋱ & ⋮ \\ {p}_{i + 1 , j} & ⋯ & {p}_{i + 1 , j + k}\end{matrix} ]$$

is a representative of together with the surrounding pixels to process the pixels into calculation in order to reduce the error.

$$[ \begin{matrix}{a}_{i , j} & ⋯ & {a}_{i , j + k} \\ ⋮ & ⋱ & ⋮ \\ {a}_{i + 1 , j} & ⋯ & {a}_{i + 1 , j + k}\end{matrix} ]$$

is a representative of a specific process for together with the surrounding pixels to process the pixels. For example, when the Gauss coefficient is used,

$$[ \begin{matrix}{a}_{i , j} & ⋯ & {a}_{i , j + k} \\ ⋮ & ⋱ & ⋮ \\ {a}_{i + 1 , j} & ⋯ & {a}_{i + 1 , j + k}\end{matrix} ] is [ \begin{matrix}1 & 2 & 1 \\ 2 & 4 & 2 \\ 1 & 2 & 1\end{matrix} ] .$$

That is, higher weights are allocated for the pixels to process in the middle, and lower weights are allocated for the surrounding pixels. There are details about process of filling or image for the edge or corner pixels. The details are all well known to those of average skill in this art, and thus further explanation of the details and operations are omitted herein for the sake of brevity.

As mentioned above, when the motion strength Difference is larger, it means that the motion level is higher, and it means that the pixel tends to not need filtering process in time domain to reduce the side effects of the ghosting, and thus the corresponding filtering coefficient is larger. When the motion strength Difference is smaller, the corresponding filtering coefficient is smaller. A first dynamic threshold value thd_{dynamic1} is obtained by adding the skin color threshold value thdₛₖᵢₙ, the Weber threshold value thd_{weber}_{_{—}}ₘᵢₙ, and a first predetermined threshold value thd1, and a second dynamic threshold value thd_{dynamic1} is obtained by adding the skin color threshold value thdₛₖᵢₙ, the Weber threshold value thd_{weber}_{_{—}}ₘᵢₙ, and a second predetermined threshold value thd2, as shown in equation (4) and equation (5).

thd_{dynamic1}=thd1+thdₛₖᵢₙ+thd_{weber} (4)

thd_{dynamic2}=thd2+thdₛₖᵢₙ+thd_{weber} (5)

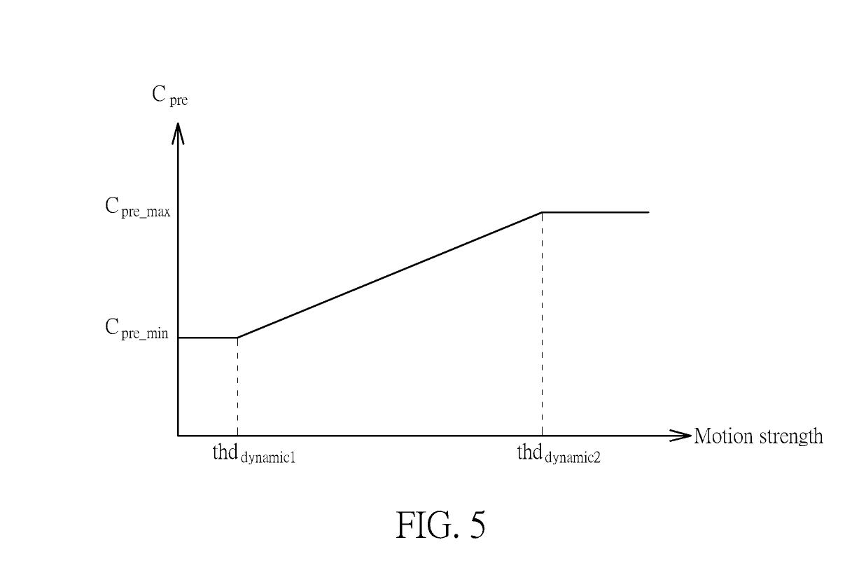

The first predetermined threshold value thd1 and the second predetermined threshold value thd2 can be optimal values adjusted are according to the use of the lens and/or light sensing element. Next, a preposed de-noising coefficient Cₚᵣₑ_{_{—}}ₖ is obtained according to the calculated motion strength Difference. Please note that for the current frame and the previous k (k=1˜n) frames, a number n of preposed de-noising coefficients Cₚᵣₑ_{_{—}}ₖ (k=1˜n) should be obtained, respectively. FIG. 5 is a relation diagram of the motion strength and the preposed de-noising coefficient of the present invention.

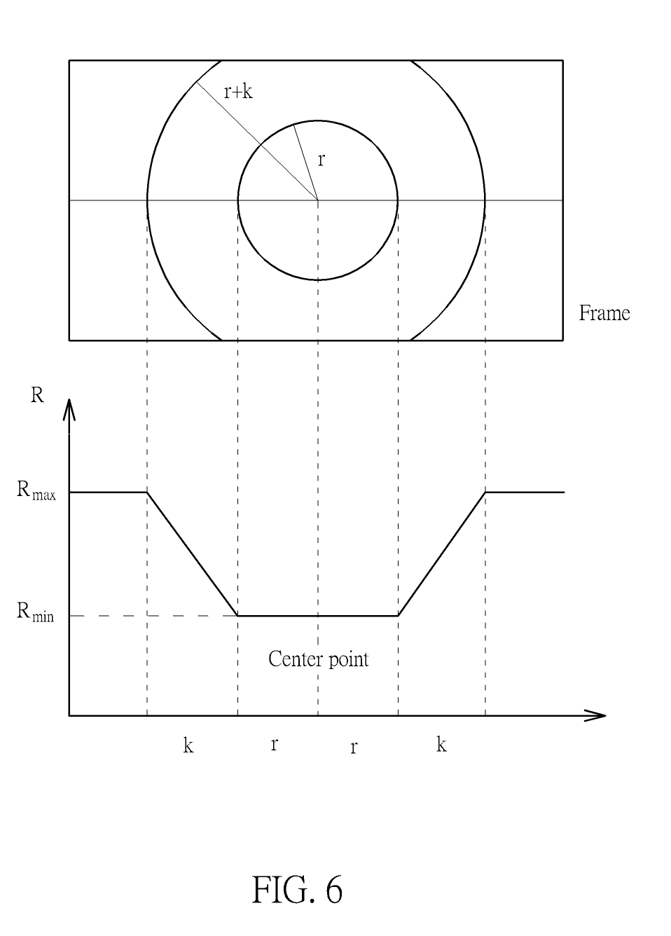

In the step 308, a distance between the pixel in the current frame and the center point of the frame is calculated (i.e. Distance Condition). The purpose of the step 308 is to adjust the coefficient obtained in the step 306 according to the distance between the pixel in the current frame and the center point of the frame. In general, if the pixel is farther from the center point of the frame, the pixel will be affected by the lens shading more seriously, and thus a bigger gain is required to amplify the pixel value, which results in the pixel farther from the center point of the frame has more serious noises than the center point of the frame. Thus, the pixel farther from the center point of the frame needs stronger filtering to improve the above noises. Since the pixel farther from the center point of the frame does not belong to the images of attention due to its position, the caused side effect of the ghosting effect is less easy to be detected. When the pixel is closer to the center point of the frame, the filtering strength is weaker. In this way, in the step 308, the corresponding adjusting coefficient R is obtained according to the information of the distance from the center point of the frame, to adjust the preposed de-noising coefficients Cₚᵣₑ_{_{—}}ₖ (k=1˜n) calculated in the step 306. FIG. 6 is a relation diagram of the distance from the center point of the frame and the adjusting coefficient in accordance with an embodiment of the present invention, wherein the distance is calculated by two norm, that is, the distance from the center point of the frame is calculated by using the Pythagorean theorem.

Distance=\sqrt{(Pₓ−Cₓ)²−(P_{y}−C_{y})²} (6)

Pₓ is X coordinate of the current pixel, and P_{y} is Y coordinate of the current pixel, and Cₓ is X coordinate of the current pixel, and C_{y} is Y coordinate of the current pixel. As shown in FIG. 6, if the calculated distance Distance is shorter than a first predetermined distance r, then the adjusting coefficient R will be set to a minimum adjusting coefficient Rₘᵢₙ. If the calculated distance Distance is longer than a second predetermined distance r+k, then the adjusting coefficient R will be set to a maximum adjusting coefficient Rₘₐₓ. If the distance is between r and r+k, then the adjusting coefficient R can be obtained by the using linear interpolation. After the adjusting coefficient R is obtained, the individual de-noising coefficient Cₖ can be obtained by adjusting the preposed de-noising coefficients Cₚᵣₑ_{_{—}}ₖ calculated in the step 306 according to the following equation (7).

Cₖ=Cₚᵣₑ_{_{—}}ₖ*R (7)

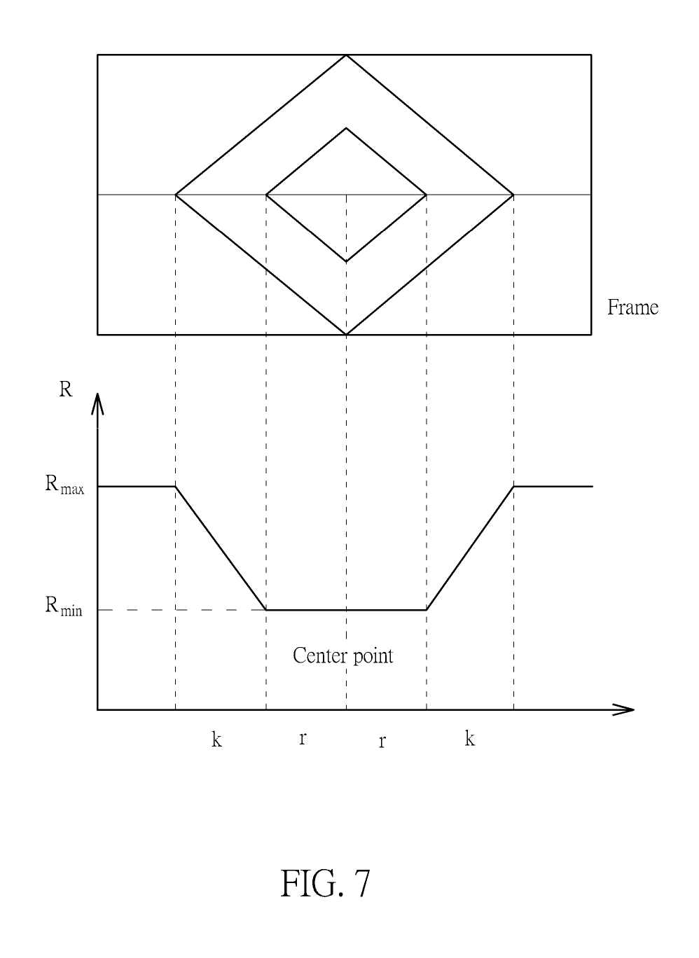

However, the lens shading compensation method utilized by the present invention is not limited to the embodiment in FIG. 6. For example, FIG. 7 is a relation diagram of the distance from the center point of the frame and the adjusting coefficient in accordance with another embodiment of the present invention, wherein the distance is calculated by one norm, that is, the distance from the center point of the frame is calculated by using the quadrilateral way. In any case, various modifications and alterations of the compensation method should fall into the disclosed scope of the present invention as long as they are based on the lens shading compensation.

In the step 310, the individual de-noising coefficients Cₖ (k=1˜n) are put in the equation (2) to obtain the result Pₒᵤₜ. Please refer to the above paragraphs for the details.

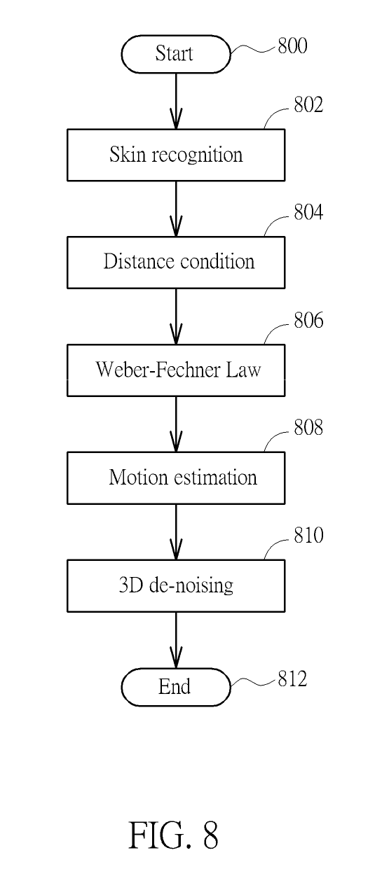

Please refer to FIG. 8. FIG. 8 shows a flowchart of an exemplary real-time adaptability 3D dynamic de-noising method in accordance with a second embodiment of the present invention. The flowchart comprises all the steps in the flowchart of the real-time adaptability 3D dynamic de-noising method in FIG. 3, but the order is changed. Specifically, the difference of the flowchart in FIG. 8 and FIG. 3 is that the distance is calculated before the Weber-Fechner Law and the motion estimation. Therefore, the equation (4) and the equation (5) are changed to be the following equation (8) and equation (9).

thd_{dynamic1}=thd1+thdₛₖᵢₙ+thd_{dist}+thd_{weber} (8)

thd_{dynamic2}=thd2+thdₛₖᵢₙ+thd_{dist}+thd_{weber} (9)

A distance threshold value thd_{dist} calculated in the step 804 is increased. Thus, provided that substantially the same result is achieved, the steps of the real-time adaptability 3D dynamic de-noising method flowchart do not have to be in the specific order, and these are all fall within the scope of the present invention.

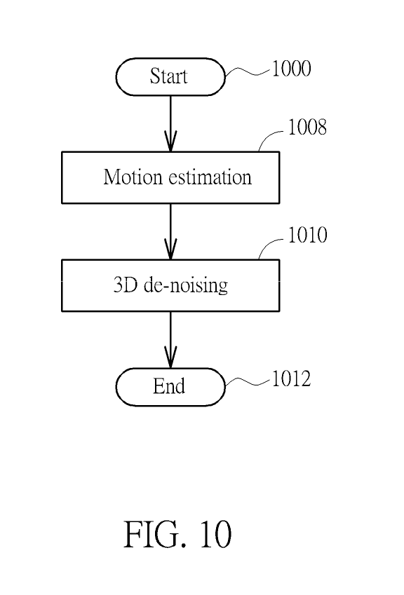

In general, in a low brightness environment, the received the pixels will be multiplied by a bigger gain before processed by the real-time adaptability 3D dynamic de-noising method of the present invention, and thus the noises will be amplified synchronously and particularly apparent. Thus, the strength of noise filtering has to be relatively increased in this condition. On the contrary, if the environmental brightness is enough, the noise is not obvious, so in this case the strength of the noise filtering should be relatively reduced, otherwise it may affect the image clarity or cause other side effects. The present invention can make optimization of adjustment according to the ambient light and brightness. In another embodiment, the steps 802, 804, and 806 in FIG. 8 can be omitted, as shown in FIG. 10.

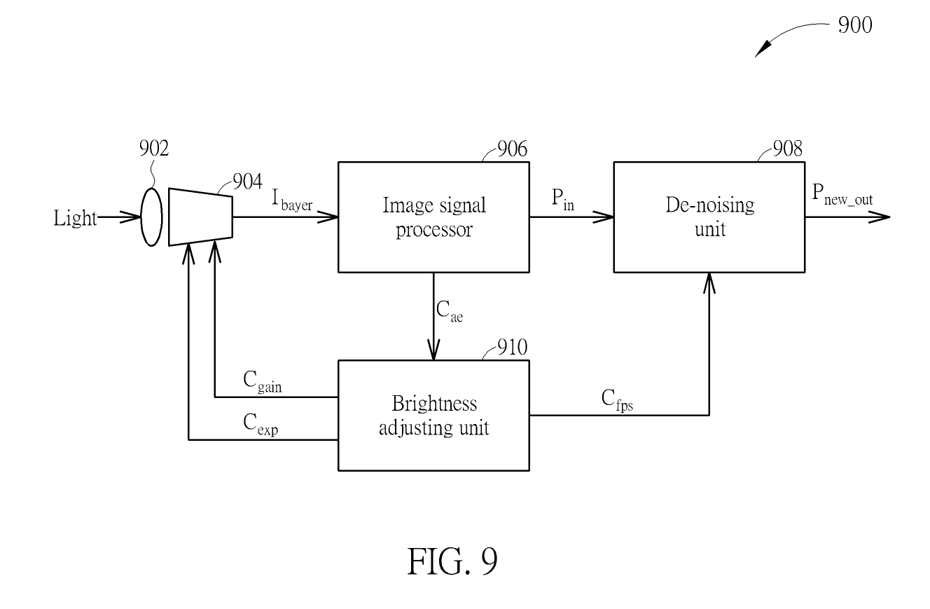

Please refer to FIG. 9. FIG. 9 is a block diagram of an image system 900 in accordance with an embodiment of the present invention. The image system 900 comprises: a lens 902, a sensor 904, an image and signal processor (ISP) 906, a de-noising unit 908, and a brightness adjusting unit 910. For example, the lens 902 and the sensor 904 can be a part or all of a lens module. After the light enters into the sensor 904 via the lens 902, the sensor 904 will convert the captured image to an image signal I_{bayer} of a specific image format, wherein the specific image format is a Bayer pattern in this embodiment, but this is not a limitation of the present invention. Next, the image signal I_{bayer} is transmitted to the ISP 906, and the ISP 906 converts the image signal I_{bayer} to an image signal Pᵢₙ of another specific image format by some image processing procedures, wherein the specific image format is a YUV signal format in this embodiment, but this is not a limitation of the present invention. Meanwhile, the ISP 906 will also further generate an automatic exposure information Cₐₑ to the brightness adjusting unit 910. The brightness adjusting unit 910 can perform related automatic exposure algorithm according to the automatic exposure information Cₐₑ, and generate a frame rate information C_{fps} to the de-noising unit 908, and further generate a gain control signal C_{gain} and a exposure control signal Cₑₓₚ to the sensor 904. Next, the de-noising unit 908 will perform the de-noising algorithm according to the received image signal Pᵢₙ and the frame rate information C_{fps}, so as to generate an image output signal P_{new}_{_{—}}ₒᵤₜ. In general, the brightness adjusting unit 910 can be realized by firmware, and the de-noising unit 908 can be realized by software, such as a software driver, but this is not a limitation of the present invention.

For the de-noising unit 908, in order to obtain the environment light source and the environment brightness to achieve the optimal de-noising effect, the frame rate information C_{fps} can be utilized to derive the environment light source and the environment brightness. Specifically, when the environment brightness is brighter, the frame rate information C_{fps} will be higher. When the environment brightness is darker, the brightness adjusting unit 910 will actively increase the exposure time of the sensor 904 to lower the frame rate information C_{fps}. In other words, when the environment brightness is brighter, the frame rate information C_{fps} is higher than that when the environment brightness is darker.

The de-noising noise unit 908 can only use the real-time adaptability 3D dynamic de-noising method in FIG. 3 or FIG. 4 without using the frame rate information C_{fps} as one of the factors, and directly use the generated real-time adaptability 3D dynamic de-noising image output Pₒᵤₜ as an output P_{new}_{_{—}}ₒᵤₜ of the de-noising noise unit 908. Besides, the de-noising noise unit 908 also can use the real-time adaptability 3D dynamic de-noising method in FIG. 3 or FIG. 4 to calculate the de-noising image output Pₒᵤₜ and obtain an optimal output P_{new}_{_{—}}ₒᵤₜ according to the frame rate information C_{fps}.

P_{new}_{_{—}}ₒᵤₜ=Pᵢₙ×α+Pₒᵤₜ×(1−α) (8)

α is between 0 and 1, and used to determine the strength of the de-noising effect. The calculation of α is as follows:

α=ƒ₄(C_{fps}) (9)

ƒ₄ is a monotone increasing function. When the frame rate information C_{fps} is higher, a is bigger, and the optimal output P_{new}_{_{—}}ₒᵤₜ is closer to Pᵢₙ. That is, when the environment light source is brighter, the de-noising effect will be lower, and when the environment light source is darker, the de-noising effect will be higher. In this embodiment, the environment light source is obtained by the frame rate information C_{fps}, but this is not a limitation of the present invention. In addition, the de-noising noise unit 908 can also use other de-noising methods with the equation (8) and the equation (9) to obtain dynamic results considering the environment light source. Above all fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A de-noising method, comprising:
receiving a pixel of a current frame;
deriving a de-noising coefficient according to a specific information corresponding to the pixel; and
generating an output pixel by allocating a weight of the pixel and a weight of at least one pixel of a previous frame according to the de-noising coefficient, wherein the at least one pixel of the previous frame includes a co-located pixel.

2. The de-noising method of claim 1, wherein the specific information comprises at least one spatial domain information and at least one time domain information.

3. The de-noising method of claim 2, wherein the least one spatial domain information comprises at least one of a skin recognition information, a brightness information, and a distance information between the pixel and a center point of the current frame, and the at least one time domain information comprises at least one motion estimation information.

4. The de-noising method of claim 3, wherein the step of deriving the de-noising coefficient according to the specific information comprises:
deriving a number N of motion estimation information respectively according to the pixel of the current frame and at least one pixel of each previous frame of a number N of previous frames, wherein the number N is greater than or equal to than 1, and the at least one pixel of each previous frame of the number N of previous frames comprises a co-located pixel; and
deriving the de-noising coefficient according to at least one of the skin recognition information, the brightness information, and the distance information between the pixel and the center point of the current frame, and the number N of motion estimation information.

5. The de-noising method of claim 4, wherein at least one pixel of each previous frame of a number N of previous frames further comprises at least one pixel surround the co-located pixel.

6. The de-noising method of claim 4, wherein the step of deriving the de-noising coefficient according to at least one of the skin recognition information, the brightness information, and the distance information between the pixel and the center point of the current frame, and the number N of motion estimation information comprises:
for each motion estimation information the number N of motion estimation information:
deriving a preposed de-noising coefficient according to at least one of the skin recognition information, the brightness information, and the distance information between the pixel and the center point of the current frame, and the number N of motion estimation information; and
performing a specific process for the number N of preposed de-noising coefficients to obtain the de-noising coefficient.

7. The de-noising method of claim 6, wherein the specific process derives a mean value of the number N of preposed de-noising coefficients to obtain the de-noising coefficient.

8. The de-noising method of claim 6, wherein the specific process derives a maximum value of the number N of preposed de-noising coefficients to obtain the de-noising coefficient.

9. The de-noising method of claim 3, wherein the least one spatial domain information comprises the skin recognition information, and when the skin recognition information indicates that the pixel of the current frame is closer to the skin color, then the weight of the pixel of the current frame is higher and the weight of the at least one pixel of the previous frame is lower.

10. The de-noising method of claim 3, wherein the least one spatial domain information comprises the brightness information, and when the brightness information indicates that the brightness of the current frame is lower, then the weight of the pixel of the current frame is higher and the weight of the at least one pixel of the previous frame is lower.

11. The de-noising method of claim 3, wherein the least one spatial domain information comprises the distance information, and when the distance information indicates that the pixel of the current frame is closer to the center point of the current frame, then the weight of the pixel of the current frame is higher and the weight of the at least one pixel of the previous frame is lower.

12. The de-noising method of claim 1, wherein at least one pixel of the previous frame further comprises at least one pixel surround the co-located pixel.

13. The de-noising method of claim 1, further comprising:
adjusting a weight of the pixel and a weight of the output pixel according to a frame rate information, so as to generate another output pixel.

14. The de-noising method of claim 13, wherein the step of adjusting the weight of the pixel and the weight of the output pixel according to a frame rate information comprises:
when the frame rate information indicates that a frame rate is higher, then setting the higher weight of the pixel and setting the lower weight of the output pixel.

15. An image system, comprising:
a lens module, for capturing an image information;
an image and signal processor, coupled to the lens module, for converting the image information to a frame; and
a de-noising unit, coupled to the image and signal processor, for:
receiving a pixel of the frame;
deriving a de-noising coefficient according to a specific information corresponding to the pixel; and
generating an output pixel by allocating a weight of the pixel and a weight of at least one pixel of a previous frame according to the de-noising coefficient, wherein the at least one pixel of the previous frame includes a co-located pixel.

16. The image system of claim 15, wherein the specific information comprises at least one of a skin recognition information, a brightness information, and a distance information between the pixel and a center point of the current frame, and at least one motion estimation information.

17. An image system, comprising:
a lens module, for capturing an image information;
an image and signal processor, coupled to the lens module, for converting the image information to a frame;
a brightness adjusting unit, coupled between the image and signal processor and the lens module, for generating an exposure control signal to the lens module according to an automatic exposure information and generating a frame rate information to a de-noising unit; and
the de-noising unit, for:
receiving a pixel of the frame;
deriving a de-noising coefficient according to a specific information corresponding to the pixel; and
generating an output pixel by allocating a weight of the pixel and a weight of at least one pixel of a previous frame according to the de-noising coefficient, wherein the at least one pixel of the previous frame includes a co-located pixel, and at least one pixel of the previous frame further comprises at least one pixel surround the co-located pixel.

18. An image system, comprising:
a lens module, for capturing an image information;
an image and signal processor, coupled to the lens module, for converting the image information to a frame;
a brightness adjusting unit, coupled between the image and signal processor and the lens module, for generating an exposure control signal to the lens module according to an automatic exposure information and generating a frame rate information to a de-noising unit; and
the de-noising unit, for performing a spatial domain de-noising process and a time domain de-noising process at least according to the frame rate information and a pixel of the frame, so as to generate an output pixel.

19. The image system of claim 18, wherein the de-noising unit adjusts a de-noising strength of the time domain for the pixel of the frame at least according to the frame rate information, so as to generate the output pixel.

20. The image system of claim 19, wherein when the frame rate information is higher, the de-noising strength of the time domain of the de-noising unit is lower.
